(19) United States
(12) Patent Application Publication
(10) Pub. No.: US 2015/0146439 A1
(43) Pub. Date: May 28, 2015

(54) LIGHTING ARRANGEMENT

(71) Applicant: Pere Llonch Fontanet, El Prat de Llobregat, (Barcelona) (ES)

(72) Inventor: Pere Llonch Fontanet, El Prat de Llobregat, (Barcelona) (ES)

(73) Assignee: GRUPO T DIFFUSION S.A., El Prat De Llobregat (Barcelona) (ES)

(21) Appl. No.: 14/388,084

(22) PCT Filed: Mar. 27, 2012
(86) PCT No.: PCT/ES2012/070206

§ 371 Date: Jan. 2, 2015

(51) Int. Cl. F21V 21/108; F21V 21/26; F21V 21/04

(52) U.S. Cl. CPC F21V 21/108; F21V 21/047; F21V 21/26
USPC 362/404

(57) ABSTRACT

The invention relates to a lighting arrangement comprising, among others, means for supporting rods from the ceiling, light fixtures at the lower ends of the rods, and coupling means between the supporting means and the rods, allowing a modular light fixture to be installed with multiple configurations.

The invention is characterised in that it comprises one or more nodes, each node occupying coordinates that are pre-determined using a corresponding configuration method, with one or more holes being made in the ceiling or roof, into which a support or rosette is inserted in order to act as a supporting means for one or more pairs of rods at the upper end thereof, said rods being of equal or different length, while at the lower end the rods are connected with the incorporation of the light fixtures and/or bulbs.

### OBJECT OF THE INVENTION

More specifically the invention refers to a lighting arrangement comprising, among others, means for supporting rods from the ceiling, light fixtures at the lower ends of the rods, and coupling means between the supporting means and the rods, allowing a modular light fixture installation and multiple configurations with the same aforementioned elements.

### STATE OF THE ART

There are different types of light fixtures, on the market that can be considered state-of-the-art, including the group of fixtures designed to be suspended from the ceiling, which are basically panels including elements to support the fixture, either directly in a frame or the like or modular type fixtures which are suspended from the ceiling by wires, cables, etc.

In the case of modular light fixtures, the current technique decides on the number of modules by fully manual means, although the design and number of modules to create light environments through software, which, in addition to giving a suitable number of modules, advises on their placement at height and the placement coordinates, is not known.

Through the patent, PCT WO 2012/______, of the same owner, a ______ procedure is known, allowing the design of an arrangement in accordance with the steps indicated in the preceding paragraph, namely the lighting arrangement covered by this invention. It could not be carried out according to certain parameters without the procedure described in the aforementioned patent, whose holder is the same.

### SCOPE OF THE INVENTION

Being able to have a modular type lighting arrangement which, thanks to its formal characteristics, makes it possible to use the procedure described in the patent, PCT WO 2012/______ by taking into consideration not only the specific number of light fixtures, but their point of placement according to certain coordinates, height with regard to the walls, floor and ceilings, desired degree of lighting (light level) and other parameters.

### DESCRIPTION OF THE INVENTION

This invention is characterised as defined in claim 1.

Materials comprising the arrangement covered by the invention are:
Holders in the form of rosettes.
Rods of various lengths.
LEDs at the ends of the rods.
Other mechanical elements such as screws, spring covers, terminal blocks,
Other electrical components, ballast, connectors, electrical cables.

The recommended arrangement comprises a number of elements that are placed using suitable means at certain points on a conventional ceiling, which we shall refer to as node and can be of two types, single or double nodes, depending on the number of pairs of rods that hang from them, thanks to the provision therein of holders or rosettes, which fit into corresponding holes in the ceiling, at the coordinates previously marked by the installer of the arrangement.

The coordinates of the nodes, whether single or double, and the height of the light fixture with regard to the ceiling can be calculated by the procedure described and claimed in the patent, PCT WO 2012/______, whose owner is the same as that of this invention.

The rods used by the arrangement covered by the invention will be of the same or different length depending on the calculations and solutions obtained by the aforementioned procedure, and at the points of attachment of their lower ends, and incorporate respective light fixtures, whose nature and output will also be the result of the repeated procedure.

The holders in one of the possible embodiments have a cylindrical body, composed of a top and bottom, whose opening on the bottom half has a cover with one or more recesses so that the rods can be hung from it by their top end, the necessary electrical means to supply the light fixtures incorporated in the joint of the rods at the bottom thereof, such as connectors for connecting wires, totally conventional ballast and the like, being placed inside the holder.

Any composition in accordance with this invention will comprise one or more nodes, either single or double, provided with holders or rosettes, from which hang the corresponding rods of the same or different lengths, whereby the compositions obtained are endless.

Another object of the invention is the computer program with which the user performs the configuration procedure for a specific lighting arrangement.

Other details and characteristics of the invention shall be shown throughout the description below referring to drawings attached to this report which are shown for illustrative but not limiting purposes only in a drawing of the invention.

### DESCRIPTION OF THE DRAWINGS

Below is a list of the different parts of the invention, which are indicated in the attached drawings with their respective numbers; (10) light fixtures, (11) nodes, (12) holes, (13) ceiling or wall, (14) springs, (15) nodes, (16) holes, (17) node, (18) hole, (19) rosette, (20-21) rods, (22) holder, (23) composition, (24) holder, (25) cover, (26-27) terminal blocks, (28-29-30) arrangements, (31) top part, (32) bottom part, (33) skirt, (34) waist, (35) inside of the ceiling (13), (37) recesses, (38) trim flap, (39) top part, (40) connectors.

FIG. 1 is a perspective view of a basic assembly comprising various rods (20-21) of the same or different lengths, a rosette (19) and a holder (22), with a light fixture (10) at the ends of the rods (20-21), in this case forming a composition (23) of a single light fixture (10).

FIG. shows the configuration of a holder (22) being:

(a) a perspective view of a holder (22), which is adapted to be fitted into a corresponding hole (12) provided in the ceiling or wall (13); and

(b) a lower perspective view and a front elevation view of the light fixture (10) holder (22) once fitted in the ceiling or wall (13), with the aid of retaining springs (14).

FIG. shows the configuration of a rosette (19) being:

(a) a perspective view of a rosette (19), which is fitted into a corresponding hole (16) provided in the ceiling or wall (13).

(b) a lower perspective view and a front elevation view of the light fixture (10) rosette (19) once fitted, in the ceiling or wall (13), with the aid of several retaining springs (14′).

FIG. 4 shows various detailed perspective views of the different, stages of mounting as the top end of the rod (20) of a holder (22) fits into the recess (37) of the cover (25).

FIG. 5 shows various detailed perspective views of the different stages of mounting as the top ends of two rods (20) and (21) of a holder (22) fits into the respective recesses (37) of the cover (25);

FIG. 6 shows a perspective view of a second basic assembly comprising various rods (20-21) various rods of the same or different lengths, a rosette (19) and various holders (22), wherein the respective holders (22) are fitted in the top ends of the rods (20-21) and both ends are attached at the bottom ends and a light fixture (10) is fit at this attachment point forming, in this case, a basic composition (23) of a single light fixture (10); and

FIG. 7 is:

(a) a front elevation view of three compositions (28-29-30), by means the arrangement covered by the invention; and

(b) a top plan view of the same arrangements (28-29-30) of the view 6a.

### DESCRIPTION OF THE EMBODIMENT OF THE INVENTIONS

In one of the preferred embodiments of the invention the recommended arrangement, is embodied in various forms, as shown with the aid of FIGS. 7a and 7b, which, in a very general way, show a ceiling (13) with nodes (11) and (15), in the respective holes (16-18) previously made in the ceiling (13), from which hang rods (20-21) with the light fixtures (10) at the bottom ends thereof. Rods (20-21) may be of the same or different lengths and be mounted with a greater or lesser inclination in relation to an ideal vertical axis.

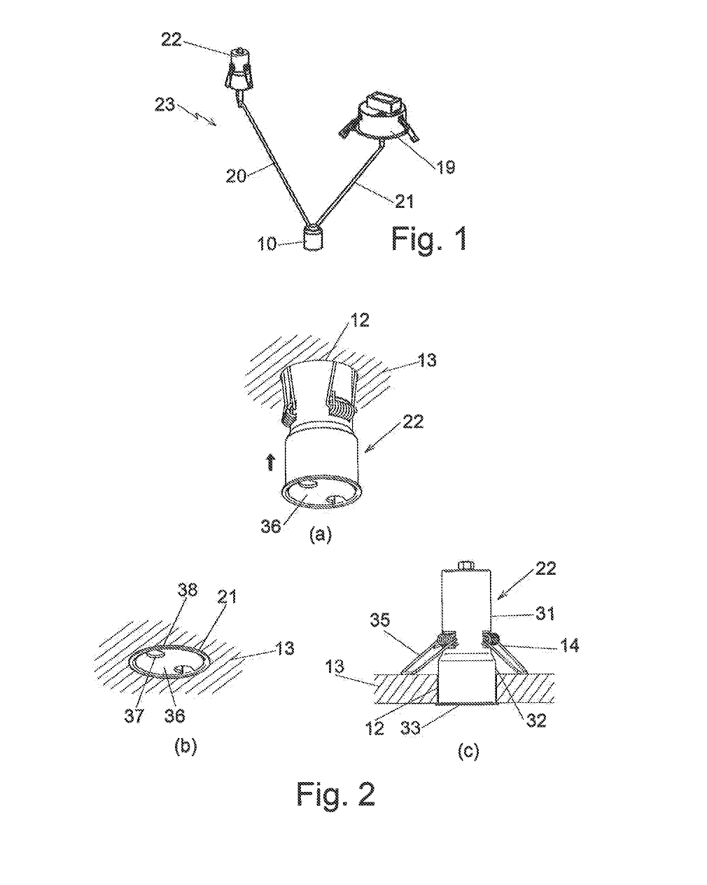

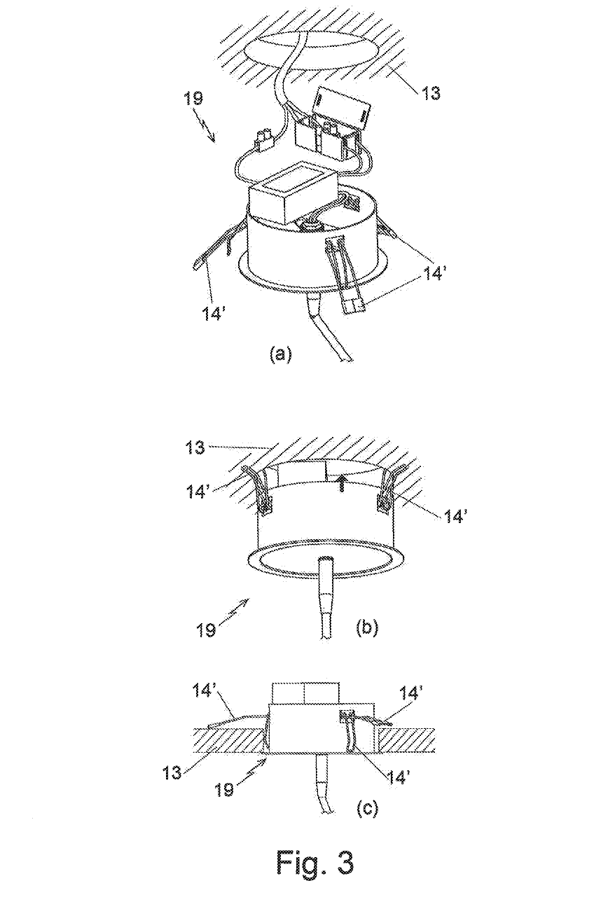

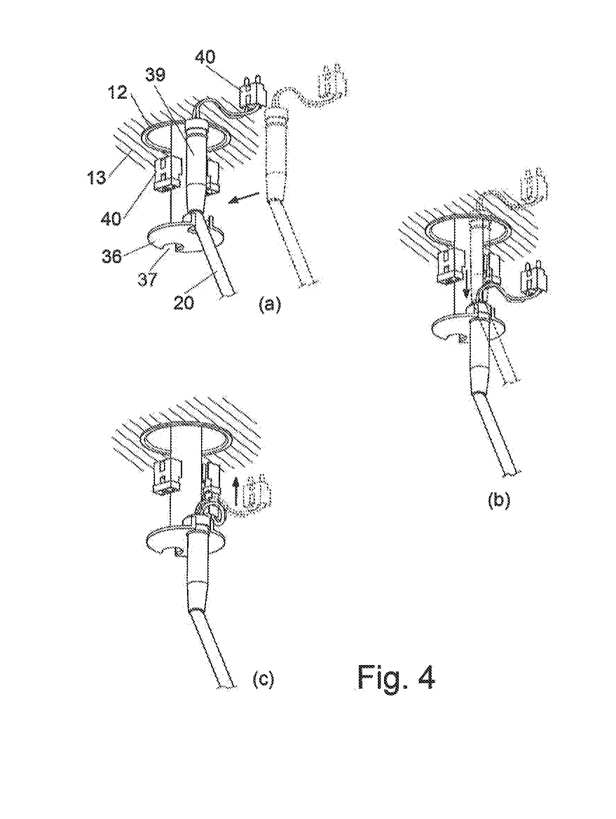

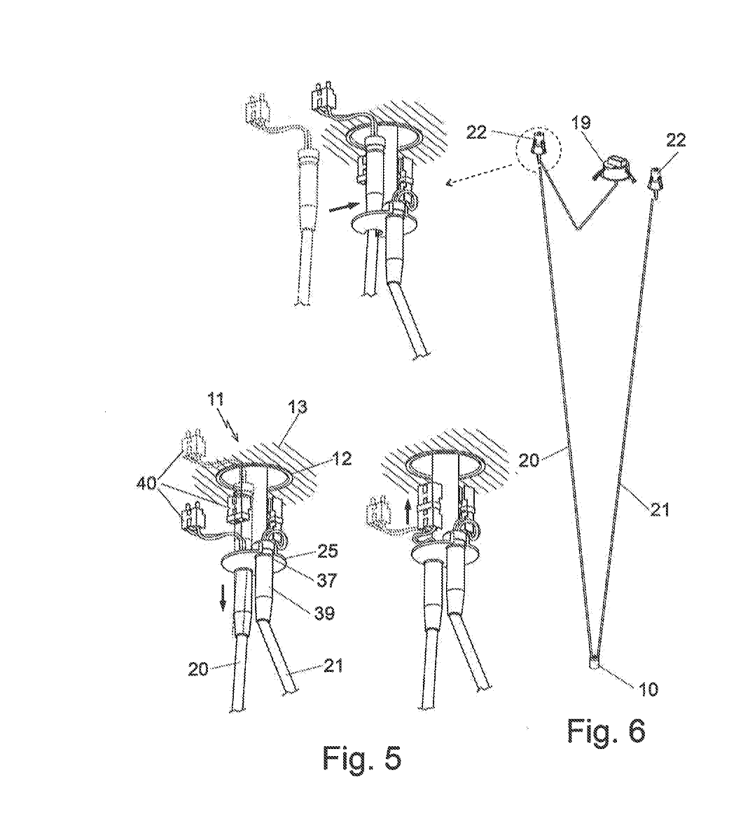

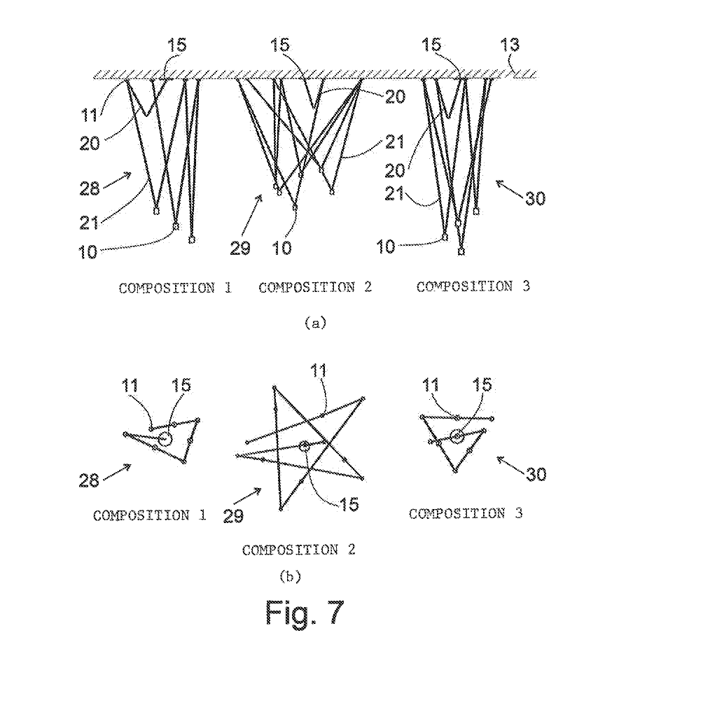

Nodes (11) and (15) may be single or double depending on the number of rods (20-21) they include. For example, FIG. 1 (a) shows the holder (22), consisting of a top (31) and bottom (32) joined (31-32) at the waist (34), which fits in the hole (12) provided in the ceiling (13), with the aid of the compressed springs (14) as shown in view (a) of FIG. 1, view (b) showing the extended springs (14) in the hole (12), these springs (14) being supported on the inside (35) of the ceiling (13), while the holder (22) is fully installed in the hole (12) such that the skirt-shaped trim (33) is flush with the exposed face of the ceiling (13).

The bottom (32) or the holder (22) houses the electrical means of the light fixture (10) with the aid of the cover (36), provided with the recesses (37) to hold the rods (20-21) as shown in FIGS. 5 and 6, where it can be seen how these rods (20-21) are attached at the top end (39) with the corresponding connectors (40).

One of the many possible compositions (23) is formed, as shown in FIG. 1, by a rosette (19) from which hangs a rod (21) attached to another rod (20), the top of which is suspended from the holder (22), the light fixture (10) being installed at the junction of the rods (20-21).

In the case of double nodes (11), two rods (20-21) are hung by their top ends (39) in the cover (25) recesses (37), as shown in FIG. 6, the variations of the composition being endless, and to better illustrate this description some of these are represented in FIG. 7, variations (28-29-30).

Having sufficiently described this invention, with correspondence to the attached drawings, it is easy to see that any sort of modification can be introduced as long as they do not change the essence of the invention, which is summarised in the following claims:

1. A lighting arrangement in spaces of any size and features, whether outdoor or indoor, provided they have a fixed ceiling or panel with the same functions as a fixed ceiling, wherein it comprises one or more nodes, each node occupying coordinates that are pre-determined using a corresponding configuration method, with one or more holes being made in the ceiling or roof, into which a support or rosette is inserted in order to act as a supporting means for one or more pairs of rods at the upper end thereof, said rods being of equal or different length, while at the lower end the rods are connected with the incorporation of the light fixtures and/or bulbs.

2. The lighting arrangement according to claim 1, wherein a holder comprises a substantially cylindrical body, with a top part with a smaller diameter than the bottom part, both parts being cylindrical, being attached at the waist, the lower part finishing in a trim flap.

3. The lighting arrangement according to claim 1, wherein the side surface of the holder includes two or more extendable springs.

4. The lighting arrangement according to claim 1, wherein the mouth of the holder houses a cover with one or more recesses which house the top end of one or more rods with a greater diameter than the latter.

5. The lighting arrangement according to claim 1, wherein the top of the rod articulates the body of the rod itself, so the latter can adopt any inclination in relation to an ideal vertical line perpendicular to the cover of the holder.

6. The lighting arrangement according to claim 1, wherein the light fixture may be one or more LEDs, light bulbs or others mounted at the bottom of the junction of the rods.

7. The lighting arrangement according to claim 1, wherein an arrangement may be formed by one or more single nodes.

8. The lighting arrangement according to claim 1, wherein an arrangement may be formed by one or more double nodes.

9. The lighting arrangement according to claim 1, wherein an arrangement may be formed by a combination of one or more nodes, either single or double.

10. The computer program performing the configuration procedure of the lighting arrangement defined in claim 1.
